(19) United States
(12) Patent Application Publication
(10) Pub. No.: US 2011/0014434 A1
(43) Pub. Date: Jan. 20, 2011

(54) Method for Producing Liquid Crystalline Polyester Prepreg and Liquid Crystalline Polyester Prepreg

(75) Inventors: Tomoko TANAKA, Niihama-shi (JP); Changbo SHIM, Tsukuba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/836,987

(22) Filed: Jul. 15, 2010

(30) Foreign Application Priority Data
Jul. 17, 2009 (JP) 2009-168477

(51) Int. Cl. B32B 3/28; B29C 70/18

(52) U.S. Cl. 428/184; 427/178

(57) ABSTRACT

The present invention provides a method for producing a liquid crystalline polyester prepreg, the method comprising steps of impregnating an inorganic fiber sheet with a solution composition containing an aromatic liquid crystalline polyester and a solvent to prepare a sheet substrate; winding the sheet substrate into a form of roll comprising two or more layers to prepare a rolled substrate; and heat-treating the rolled substrate; wherein in the step of winding, corrugated spacers placed on both sides in the traverse direction of the sheet substrate are wound together with the sheet substrate. The method is suitable for mass production of a liquid crystalline polyester prepreg and can suppress the occurrence of irregularities in quality even after heat treatment.

### BACKGROUND OF THE INVENTION

1. Field of the Invention

The present invention relates to a liquid crystalline polyester prepreg used for an insulating layer such as a core substrate for printed wiring boards, an LED (light-emitting diode) substrate or a high frequency circuit substrate, or for a reinforcing board of a flexible printed wiring board.

In addition, while “prepreg” means base materials, such as glass cloths, nonwoven fabrics, paper and the like, impregnated with a thermosetting resin such as an epoxy resin, a polyimide resin or the like as a resin material, among these prepregs, a prepreg in which liquid crystalline polyester is used as the resin material is referred to a “liquid crystalline polyester prepreg”.

2. Description of the Related Art

Generally, in producing a liquid crystalline polyester prepreg, the liquid crystalline polyester prepreg is preferably subjected to a heat treatment for the purpose of improving the orientation and molecular weight of liquid crystalline polyester after undergoing a resin-impregnating step and a primary drying step.

Hitherto, as such a method of a heat treatment, a technique for forming a prepreg into a plate and heating the formed prepreg with a belt conveyor (hereinafter, referred to as publicly known technique 1) has been proposed (see, for example, JP-A-2000-174438 and JP-A-Hei03-81122). However, it is required to drive a belt conveyor at a low rate for adequately heating the prepreg by use of the publicly known technique 1. Consequently, in this method, not only a wide space for the heat treatment and much energy are required, but also work efficiency is low because time for heating the prepreg is long. Therefore, the publicly known technique 1 is not suitable for the mass production of a liquid crystalline polyester prepreg.

Further, as another method for a heat treatment, a technique for placing a prepreg in a hot air circulating thermostat and heating the prepreg (hereinafter, referred to as publicly known technique 2) has also been proposed (see, for example, JP-A-Hei11-87861). However, in the publicly known technique 2, since a degree of heating varies from location to location in the thermostat, there is an inconvenience of adjusting the degree of heating. Therefore, the publicly known technique 2 is also unsuitable for the mass production of a liquid crystalline polyester prepreg.

In order to solve these disadvantages, it is conceivable to wind a liquid crystalline polyester prepreg into a roll and heat the liquid crystalline polyester prepreg wound into a roll. This makes it possible to mass-produce the liquid crystalline polyester prepreg.

### SUMMARY OF THE INVENTION

However, when the liquid crystalline polyester prepreg wound into a roll is heated, heat transfer during heating differs between the surface section and the core side section of the liquid crystalline polyester prepreg wound into a roll. Accordingly, the liquid crystalline polyester prepreg thus heated has a possibility of the occurrence of irregularities in quality (physical properties such as thickness, strength and the like).

In view of the above state of the art, it is a first object of the present invention to provide a method for producing a liquid crystalline polyester prepreg which is suitable for the mass production of a liquid crystalline polyester prepreg and can suppress the occurrence of irregularities in quality after the heat treatment, and further it is a second object of the present invention to provide a liquid crystalline polyester prepreg substantially free from the irregularities in quality.

The present inventors have made earnest investigations in order to achieve these objectives, and consequently have noted that spacers placed on both sides of a sheet substrate are wound together with the sheet substrate so as to evenly supply hot air, for example, from both sides in the traverse direction of the sheet substrate toward a central portion in the traverse direction when heating the rolled substrate. These findings have now led to completion of the present invention.

Namely, the present invention provides a method for producing a liquid crystalline polyester prepreg, the method comprising steps of:

impregnating an inorganic fiber sheet with a solution composition containing an aromatic liquid crystalline polyester and a solvent to prepare a sheet substrate;

winding the sheet substrate into a form of roll comprising two or more layers to prepare a rolled substrate; and

heat-treating the rolled substrate;

wherein in the step of winding, corrugated spacers placed on both sides in the traverse direction of the sheet substrate are wound together with the sheet substrate.

In accordance with the present invention, since the heat treatment of the rolled substrate is performed in a rolled state, it is possible to provide a method for producing a liquid crystalline polyester prepreg, which is suitable for the mass production of a liquid crystalline polyester prepreg. Furthermore, since hot air is evenly supplied from both sides in the traverse direction of the rolled substrate toward a central portion in the traverse direction when heating the rolled substrate, it becomes possible to prevent the occurrence of irregularities in quality after the heat treatment. Therefore, a liquid crystalline polyester prepreg free from the irregularities in quality can be provided.

### BRIEF DESCRIPTION OF THE DRAWINGS

FIG. 1 is a sectional view of the liquid crystalline polyester prepreg of Embodiment 1 of the present invention;

FIG. 2 is a process chart showing a method for producing a liquid crystalline polyester prepreg of Embodiment 1 of the present invention;

FIG. 3 is a perspective view showing a step of winding into a roll in the method for producing a liquid crystalline polyester prepreg of Embodiment 1 of the present invention;

FIG. 4 is a sectional view of a spacer used in a step of winding into a roll in the method for producing a liquid crystalline polyester prepreg of Embodiment 1 of the present invention; and

FIG. 5 is a bar chart showing 90° peel strength of a copper-clad laminate formed by sandwiching the liquid crystalline polyester prepreg between copper foils and pressing the liquid crystalline polyester prepreg with copper foils.

### DETAILED DESCRIPTION OF THE PREFERRED EMBODIMENT

A method for producing a liquid crystalline polyester prepreg in the present invention comprises the steps of impregnating an inorganic fiber sheet with a solution composition containing an aromatic liquid crystalline polyester and a solvent to prepare a sheet substrate; winding the sheet substrate into a form of roll comprising two or more layers to prepare a rolled substrate; and heat-treating the rolled substrate. In the step of winding, corrugated spacers placed on both sides in the traverse direction of the sheet substrate are wound together with the sheet substrate.

For example, the method for producing a liquid crystalline polyester prepreg in the present invention comprises the steps of:

impregnating an inorganic fiber sheet with a solution composition containing an aromatic liquid crystalline polyester and a solvent to prepare a sheet substrate;

winding the sheet substrate into a roll of two or more layers to prepare a rolled substrate; and

heat-treating the rolled substrate;

wherein in the step of winding into a roll, spacers, placed on both sides in the traverse direction of the sheet substrate, are wound together with the sheet substrate so that an air passage from both sides in the traverse direction of the rolled substrate to a central portion in the traverse direction is provided for each space between the respective layers adjacent to each other in the radial direction of the rolled substrate.

Hereinafter, embodiments of the present invention will be described.

### Embodiment 1 of the Present Invention

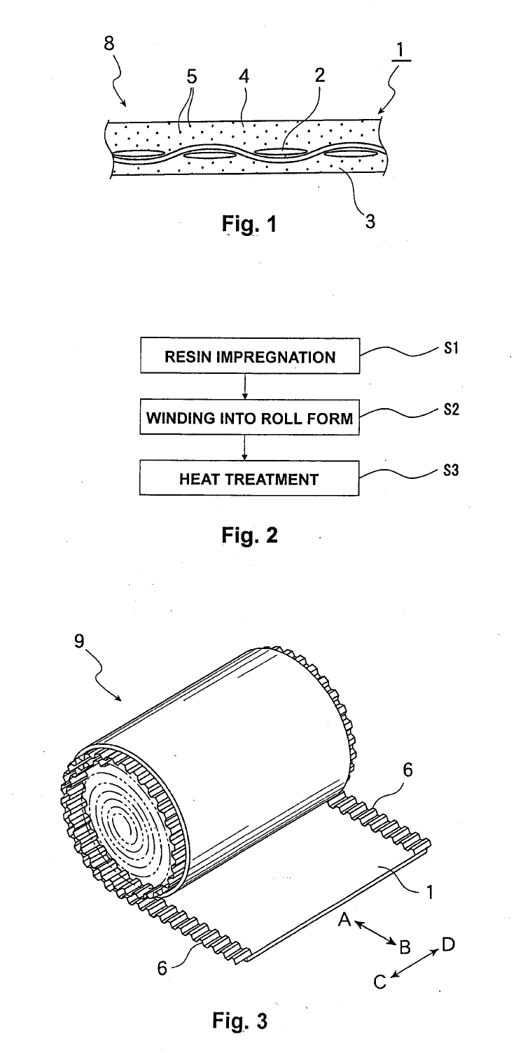

FIGS. 1 to 4 show Embodiment 1 of the present invention. In this Embodiment 1, with respect to a liquid crystalline polyester prepreg 1, a constitution and a production method thereof will be sequentially described. In addition, in FIG. 1, since a constitution is illustrated with the emphasis on ease of understanding, each component is not necessarily drawn exactly to scale.

### <Constitution of Liquid Crystalline Polyester Prepreg>

First, the constitution of the liquid crystalline polyester prepreg 1 will be described.

This liquid crystalline polyester prepreg 1 has a glass cloth 2 having a predetermined thickness (for example, 10 to 200 μm) as shown in FIG. 1. The glass cloth 2 is impregnated with a resin layer 3 and the resin layer 3 includes inorganic fillers 5 with the inorganic fillers evenly dispersed in an aromatic liquid crystalline polyester 4.

As the glass cloth 2, glass clothes composed of alkali-containing glass fibers, alkali-free glass fibers, or low-dielectric glass fibers are preferred. Further, ceramic fibers made of ceramic other than glass or carbon fibers may be partially admixed as fibers constituting the glass cloth 2. Furthermore, the fibers constituting the glass cloth 2 may be surface treated with a coupling agent such as an aminosilane coupling agent, an epoxysilane coupling agent, or a titanate coupling agent.

The aromatic liquid crystalline polyester 4 contained in the resin layer 3 has a flow beginning temperature of 250° C. or higher and solubility in a solvent. This solubility in a solvent means that the aromatic liquid crystalline polyester 4 is dissolved in a concentration of 1% by mass or more in a solvent at 50° C. The solvent in this case means a general-purpose solvent and is preferably an aprotic solvent not containing a halogen atom. Specific examples of such an aprotic solvent include an ether solvent such as diethyl ether, tetrahydrofuran and 1,4-dioxane; a ketone solvent such as acetone and cyclohexanone; an ester solvent such as ethyl acetate; a lactone solvent such as γ-butyrolactone; a carbonate solvent such as ethylene carbonate or propylene carbonate; an amine solvent such as triethylamineorpyridine; a nitrile solvent such as acetonitrile or succinonitrile; an amide solvent such as N,N-dimethylformamide, N,N-dimethylacetamide, tetramethylurea, or N-methyl-2-pyrrolidone; a nitro solvent such as nitromethane or nitrobenzene; a sulfur solvent such as dimethyl sulfoxide or sulforane; and a phosphorus solvent such as hexamethylphosphoric acid amide or tri-n-butyl phosphate.

The aromatic liquid crystalline polyester 4 having such solubility in a solvent is preferably a liquid crystalline polyester having structural units represented by the following formulas (1), (2) and (3):

—O—Ar¹—O— (1)

-X—Ar²—Y- (2) and

—CO—Ar³—O— (3)

in the formulas, Ar¹ represents at least one selected from the group consisting of 1,4-phenylene, 2,6-naphthylene and 4,4′-biphenylene, Ar² represents at least one selected from the group consisting of 1,4-phenylene, 1,3-phenylene and 4,4′-biphenylene, X and Y independently represent O or NH, and Ar³ represents at least one selected from the group consisting of 1,4-phenylene, 1,3-phenylene, 2,6-naphthylene and a divalent group represented by the following formula (4):

—Ar⁴—Z—Ar⁵— (4)

In the formula, Ar⁴ and Ar⁵ independently represent at least one selected from the group consisting of 1,4-phenylene, 2,6-naphthylene and 4,4′-biphenylene, and Z represents O, SO₂ or CO, wherein the amount of a structural unit represented by the formula (1) is 30 to 80% by mol, the amount of a structural unit represented by the formula (2) is 35 to 10% by mol, and the amount of a structural unit represented by the formula (3) is 35 to 10% by mol with respect to the total amounts of all structural units.

The aromatic liquid crystalline polyester 4 including these structural units has an advantage that its dimension stability is excellent and can be suitably used for an insulating layer of an SUS substrate.

The structural unit represented by the formula (1) is a structural unit derived from an aromatic hydroxycarboxylic acid, the structural unit represented by the formula (2) is a structural unit derived from an aromatic dicarboxylic acid, and the structural unit represented by the formula (3) is a structural unit derived from an aromatic diol, an aromatic diamine or an aromatic amine having a hydroxyl group, but in place of these compounds, ester-forming derivatives thereof may be used. Here, the ester-forming derivatives include derivatives which form an amide bond.

Here, examples of the ester-forming derivatives of the carboxylic acid include those in which a carboxylic group is a highly reactive derivative such as an acid chloride or an acid anhydride so as to promote a reaction to produce polyesters or polyamides; and those in which esters are formed by carboxylic groups and alcohols or ethylene glycol so as to produce polyesters through trans-esterification.

Further, examples of the ester-forming derivatives of the phenolic hydroxyl group include those in which esters are formed by phenolic hydroxyl groups and carboxylic acids so as to produce polyesters through trans-esterification.

Furthermore, examples of the ester-forming derivatives of the amino group include those in which amides are formed by amino groups and carboxylic acids so as to produce polyesters or polyamides through trans-esterification.

As the structural units of the aromatic liquid crystalline polyester 4 used in the present invention, the following structural units can be exemplified.

First, examples of the structural unit represented by the formula (1) include structural units derived from p-hydroxybenzoic acid, 2-hydroxy-6-naphthoic acid and 4-hydroxy-4′-biphenylcarboxylic acid, and two or more kinds of the structural units may be contained in all structural units. Among these structural units, it is preferred to contain a structural unit derived from 2-hydroxy-6-naphthoic acid.

The amount of this structural unit represented by the formula (1) is preferably 30 to 60% by mol, more preferably 35 to 55% by mol, and furthermore preferably 40 to 50% by mol with respect to the total amounts of all structural units. When the ratio of the structural unit represented by the formula (1) to the total of all structural units is in this range, the aromatic liquid crystalline polyester 4 exhibits adequate liquid crystallinity and has adequate solubility in a solvent, and therefore there is an advantage that the formation of the resin layer 3 becomes easy.

Examples of the structural unit represented by the formula (2) include structural units derived from terephthalic acid, isophthalic acid, 2,6-naphthalene dicarboxylic acid and 4,4′-oxydiphenyldicarboxylic acid, and two or more kinds of the structural units may be contained in all structural units. Among these structural units, an aromatic liquid crystalline polyester 4 containing a structural unit derived from isophthalic acid is preferred in that solubility in a solvent is high.

The amount of this structural unit represented by the formula (2) is preferably 35 to 20% by mol, more preferably 32.5 to 22.5% by mol, and furthermore preferably 30 to 25% by mol with respect to the total amounts of all structural units. When the ratio of the structural unit represented by the formula (2) to the total of all structural units is in this range, the aromatic liquid crystalline polyester 4 exhibits adequate liquid crystallinity and has adequate solubility in a solvent, and therefore there is an advantage that the formation of the resin layer 3 becomes easy.

Furthermore, examples of the structural unit represented by the formula (3) include structural units derived from hydroquinone, resorcin, 4,4′-dihydroxybiphenyl, 3-aminophenol, 4-aminophenol, 1,4-phenylenediamine, 1,3-phenylenediamine and 4,4′-dihydroxydiphenyl, and two or more kinds of the structural units may be contained in all structural units. Among these structural units, an aromatic liquid crystalline polyester 4 containing a structural unit, in which at least one of X and Y is NH in the structural unit represented by the formula (3), is preferred from the viewpoints of obtaining a solution composition containing the aromatic liquid crystalline polyester 4 and the solvent with ease and attaining excellent adhesion property between the resin layer 3 and an SUS foil layer, and it is preferred to use a liquid crystalline polymer containing a structural unit derived from 4-aminophenol.

The amount of this structural unit represented by the formula (3) is preferably 35 to 20% by mol, more preferably 32. 5 to 22.5% by mol, and furthermore preferably 30 to 25% by mol with respect to the total amounts of all structural units. When the ratio of the structural unit represented by the formula (3) to the total of all structural units is in this range, the aromatic liquid crystalline polyester 4 exhibits adequate liquid crystallinity and has adequate solubility in a solvent, and therefore there is an advantage that the formation of the resin layer 3 becomes easy.

Further, it is preferred that the structural unit represented by the formula (3) is substantially equivalent to the structural unit represented by the formula (2), but it is also possible to control the polymerization degree of the aromatic liquid crystalline polyester 4 by adjusting the molar ratio of the structural unit represented by the formula (3) to the structural unit represented by the formula (2) to 90 to 110% by mol.

A method for producing the aromatic liquid crystalline polyester 4 used in the present invention is not particularly limited, and examples of the method include a method in which acylated compounds are obtained by acylating, with an excessive amount of a fatty acid anhydride, phenolic hydroxyl groups or amino groups of an aromatic hydroxy acid corresponding to the structural unit represented by the formula (1), an aromatic diol corresponding to the structural unit represented by the formula (3), and an aromatic amine and/or an aromatic diamine having a hydroxyl group, and the obtained acylated compounds are subjected to melt-polymerization with an aromatic dicarboxylic acid corresponding to the structural unit represented by the formula (2) to perform trans-esterification (polycondensation) (see, for example, JP-A-2002-220444 and JP-A-2002-146003).

In the acylation reaction, the amount of the fatty acid anhydride to be added is preferably from 1.0 to 1.2 equivalents, and more preferably from 1.05 to 1.1 equivalents with respect to one equivalent of the total amount of the phenolic hydroxyl group and amino group. When the amount of the fatty acid anhydride to be added is less than 1.0 equivalent, an acylated compound, a raw material monomer or the like is sublimated during trans-esterification (polycondensation) and a reaction system tends to be clogged, and when the amount of the fatty acid anhydride to be added is more than 1.2 equivalent, the aromatic liquid crystalline polyester 4 to be obtained tends to be significantly colored.

The acylation reaction is preferably performed at 130 to 180° C. for 5 minutes to 10 hours, and more preferably performed at 140 to 160° C. for 10 minutes to 3 hours.

Further, examples of the fatty acid anhydride used for the acylation reaction include, but are not limited to, acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride, β-bromopropionic anhydride and the like, and these anhydrides may be used as a mixture of two or more of them. Among them, acetic anhydride, propionic anhydride, butyric anhydride and isobutylic anhydride are preferable from the viewpoint of their costs and ease in handling. More preferably, acetic anhydride is preferable.

In the trans-esterification, the acylated compound is preferably used in such an amount that the equivalent of the acyl group is 0.8 to 1.2 times the equivalent of the carboxyl group.

The trans-esterification is preferably performed at a temperature of 130 to 400° C. at a temperature raising rate of 0.1 to 50 ° C./min, and more preferably performed at a temperature of 150 to 350° C. at a temperature raising rate of 0.3 to 5 ° C./min.

Fatty acids obtained as by-products and unreacted fatty acid anhydride are preferably distilled off out of the reaction system by, for example, evaporation in order to shift the equilibrium in reaction according to Le Chatelier-Braun's law (principle of mobile equilibrium) during the acylation reaction and the trans-esterification.

In addition, the acylation reaction and the trans-esterification may be performed in the presence of a catalyst. The catalyst may be a conventional catalyst which has been publicly known as a polymerization catalyst for polyesters, and examples of the catalyst include metal salt catalysts such as magnesium acetate, stannous acetate, tetrabutyl titanate, lead acetate, sodium acetate, potassium acetate and antimony trioxide, organic compound catalysts such as N,N-dimethylaminopyridine and N-methylimidazole and the like.

However, these catalysts may sometimes still remain in the aromatic liquid crystalline polyester 4 without being removed from the aromatic liquid crystalline polyester 4 to be produced. Therefore, when a catalyst including a metal is used, the metal having remained in the aromatic liquid crystalline polyester 4 may sometimes adversely affect electrical properties in the resin layer 3. Accordingly, as the catalyst, an organic compound is preferred, and among them, a heterocyclic compound containing a nitrogen atom such as N,N-dimethylaminopyridine or N-methylimidazole is preferably used (see, for example, JP-A-2002-146003).

When the catalyst is used, it may exist temporarily during the acylation reaction and the trans-esterification, and therefore the catalyst may be charged concurrently with monomers for producing the aromatic liquid crystalline polyester 4 before the acylation reaction or may be charged during the acylation reaction or the trans-esterification.

The polycondensation based on the trans-esterification is generally performed by using melt-polymerization, but the melt-polymerization may be used in combination with solid phase polymerization. When the solid phase polymerization is conducted, the polymer drawn from the melt-polymerization step can be pulverized to provide a powder-form or flake-form polymer, and then can be subjected to the heat treatment. Specific examples of a method for solid phase polymerization include such as a method in which a polymer is heat treated at a temperature of 20 to 350° C. for 1 to 30 hours in a solid phase state in an atmosphere of an inert gas such as nitrogen. The solid phase polymerization may be performed while stirring the polymer, or may be performed in a state of being left standing without stirring. In addition, by installing an appropriate stirring mechanism, a melt-polymerization vessel and a solid phase polymerization vessel can be combined into one reaction vessel. After the solid phase polymerization, the resulting aromatic liquid crystalline polyester 4 may be pelletized for improving ease in handling.

Further, the aromatic liquid-crystalline polyester 4 can be produced by use of apparatuses for a batch operation, apparatuses for a continuous operation or the like.

The mass average molecular weight of the aromatic liquid crystalline polyester 4 is not particularly limited but is generally about 10000 to 500000. When the molecular weight of the aromatic liquid crystalline polyester 4 is higher, the dimension stability of the resin layer 3 containing the aromatic liquid crystalline polyester 4 tends to be favorable. As described above, it is possible to increase the molecular weight of the aromatic liquid crystalline polyester 4 by using the melt-polymerization in combination with the solid phase polymerization in producing the aromatic liquid crystalline polyester 4. However, it is desirable to determine the mass average molecular weight of the aromatic liquid crystalline polyester 4 in consideration of the solubility of the aromatic liquid crystalline polyester 4 in a solvent.

Further, examples of the inorganic fillers 5 contained in the resin layer 3 include fibrous, granular, plate-like or whisker-like inorganic fillers made of materials such as silica, glass, alumina, titanium oxide, zirconia, kaolin, calcium carbonate, calcium phosphate, aluminum borate, magnesium sulfate, zinc oxide, silicon carbide, silicon nitride and the like. Among these, granular inorganic fillers made of aluminum borate, potassium titanate, magnesium sulfate, zinc oxide, silicon carbide, silicon nitride or alumina, or fibrous fillers such as glass fiber, alumina fiber and the like are preferred. When the inorganic fillers are granular fillers, if particle diameter D10 (μm), which is corresponding to 10% of the relative particle amount from the minimum particle diameter, and particle diameter D90 (μm), which is corresponding to 90% of the relative particle amount from the minimum particle diameter, are determined in the particle size cumulative distribution determined at transmittance of about 80% by using a laser diffraction particle size distribution measuring apparatus, it is preferred that D10 is 1.0 μm or less and D90 is 5.0 μm or more for improving the dimension stability.

As a matter of course, two or more kinds of the inorganic fillers may be used. Further, one or more kinds of resin components other than the aromatic liquid crystalline polyester 4, namely, thermoplastic resins such as polypropylene, polyamide, polyester, polyphenylene sulfide, polyether ketone, polycarbonate, polyether sulfone, polyphenyl ether and modification products thereof and polyether imide; and elastomers such as copolymers of glycidylmethacrylate and polyethylene may be added to the resin layer 3 to an extent that the object of the present invention is not impaired.

The solution composition generally contains the aromatic liquid crystalline polyester 4 in an amount of 0.5 to 50% by mass, preferably 5 to 30% by mass, with respect to the solvent. When the amount of the aromatic liquid crystalline polyester 4 is small, production efficiency of the resin layer 3 tends to be reduced, and when the amount of the aromatic liquid crystalline polyester 4 is large, dissolution tends to become difficult.

The solution composition may be subjected to filtration by a filter as required so that fine impurities contained in the solution composition are removed.

In order to obtain the resin layer 3 in which the aromatic liquid crystalline polyester 4 includes the inorganic fillers 5, the solution composition may contain the inorganic fillers 5. The inorganic fillers 5 are generally used in an amount of 100 parts by mass or less, preferably 40 parts by mass or less, with respect to 100 parts by mass of the aromatic liquid crystalline polyester 4. The inorganic fillers 5 may be surface treated for enhancing the compatibility with and the adhesion property to the aromatic liquid crystalline polyester 4. As described above, when the resin layer 3 contains the inorganic fillers 5, mechanical properties such as elastic modulus and dimensional accuracy of the resin layer 3 can be enhanced.

Further, the resin layer 3 may also contains additives such as a titanium coupling agent, an anti-settling agent, an ultraviolet absorber and a heat stabilizer. At this time, two or more kinds of the additives may be used as a matter of course.

### <Method for Producing Liquid Crystalline Polyester Prepreg>

Next, a method for producing the liquid crystalline polyester prepreg 1 will be described referring to FIGS. 1 to 4.

First, in the step of resin impregnation (step S1 in FIG. 2), as shown in FIG. 1, the glass cloth 2 is impregnated with a solution composition containing the aromatic liquid crystalline polyester 4 and a solvent to prepare a sheet substrate 8.

As the solvent, an aprotic solvent not containing a halogen atom is preferably used as described above, and an aprotic polar solvent with a dipole moment of 3 to 5 is more preferably used. When the aprotic solvent not containing a halogen atom is used, 1 to 50 parts by mass, preferably 2 to 40 parts by mass, of the aromatic liquid crystalline polyester 4 is preferably dissolved in 100 parts by mass of the aprotic solvent. When the content of the aromatic liquid crystalline polyester 4 is in such a range, it is preferred in that because a disadvantage that a thickness of the liquid crystalline polyester prepreg 1 becomes uneven or the like tends to hardly arise when evaporating the solvent contained in the solution composition.

Further, one or more kinds of resins other than the aromatic liquid crystalline polyester 4, for example, thermoplastic resins such as polypropylene, polyamide, polyester, polyphenylene sulfide, polyether ketone, polycarbonate, polyether sulfone, polyphenyl ether and modification products thereof and polyether imide; elastomers typified by copolymers of glycidylmethacrylate and polyethylene; and thermosetting resins such as a phenolic resin, an epoxy resin, a polyimide resin and a cyanate resin, maybe added to the solution composition to an extent that the object of the present invention is not impaired. However, these other resins are also preferably soluble in a solvent used for the solution composition even when such other resins are used.

Furthermore, one or more kinds of organic fillers such as cured epoxy resins, cross-linked benzoguanamine resins, cross-linked acrylic polymers, and the like; and various additives such as a silane coupling agent, an antioxidant, an ultraviolet absorber and the like may be added to the solution composition to an extent that the effect of the present invention is not impaired for the purpose of improving dimension stability and thermal conductivity, but it is necessary to appropriately select the kinds and amounts of these additives to be used in order to prevent the thickness of the liquid crystalline polyester prepreg 1 to be obtained from becoming uneven.

Further, the solution composition may be subjected to filtration by a filter as required so that fine impurities contained in the solution composition are removed.

Furthermore, the solution composition may be subjected to defoaming treatment as required.

Then, the solution composition is subjected to primary drying to evaporate the solvent contained in the solution composition.

After the sheet substrate 8 is thus prepared, the sheet substrate 8 is transferred to a step of winding into a roll (step S2 in FIG. 2) and wound into a roll of two or more layers, as shown in FIG. 3, to prepare a rolled substrate 9 having an outer diameter of 30 to 500 mm. In order to achieve the preparation, for example, one end (closed end portion) of the sheet substrate 8 is fixed to a predetermined winding core (not shown) and the sheet substrate 8 is wound around the winding core.

The winding core having an outer diameter of preferably 30 to 500 mm, more preferably 40 to 300 mm, furthermore preferably 50 to 200 mm, and particularly preferably 60 to 158 mm can be applied. Further, the total outer diameter of the winding core and the sheet substrate 8 of the rolled substrate 9 before the heat treatment is preferably 60 to 500 mm, and more preferably 90 to 400 mm for the case of the winding core having an outer diameter of 60 to 158 mm. A material for the winding core is preferably a material which has heat resistance for resisting heat treatment conditions and chemical resistance and further has strength capable of carrying weights of the sheet substrate 8 and a spacer 6 during the heat treatment. Examples of such a material for the winding core include iron, copper, aluminum, titanium, nickel and alloys thereof. As the winding core, particularly, winding cores made of a magnesium-based aluminum alloy such as A 5052, A 5056 or A 5083, or stainless steel such as SUS 304, SUS 304L, SUS 316, or SUS 316L are favorable.

A rate at which the sheet substrate 8 is wound is preferably appropriately adjusted depending on the shape of the rolled substrate 9 or the dimensions of the sheet substrate 8, but for example, the rate can be set at the range of 0.1 to 100 m/min. Further, examples of a method for winding the sheet substrate include a method for winding the sheet substrate by rotating a winding portion in a forced manner, and a method in which the winding portion is configured so as to rotate freely, a proper guide roll is disposed on the way to the winding portion, and the sheet substrate 8 is sent to the winding portion by rotating the guide roll. In addition, tension may be applied to the sheet substrate 8 to such an extent that the tension does not cause break in order to prevent the sheet substrate 8 from significantly sagging when winding the sheet substrate 8.

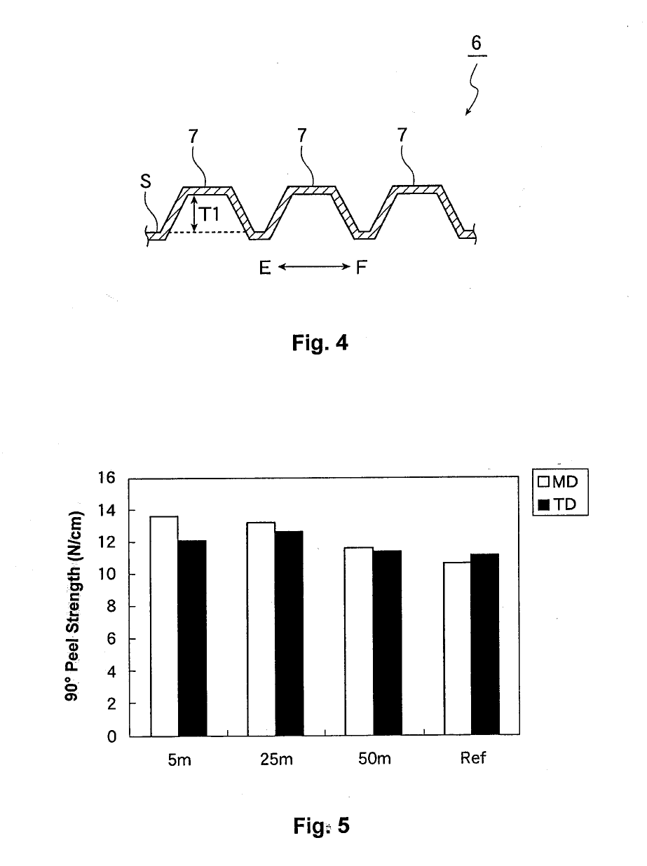

In this time, each of metal spacers 6 is wound together placed on both sides in the traverse direction (direction of arrow C-D) of the rolled substrate 9. The spacer 6 has a corrugated (or wave-like) shape in cross section as shown in FIG. 3 and FIG. 4, and a distance between a plane connecting apexes of a plurality of convex portions 7 and a reference plane S where the convex portion 7 is not formed, namely an apparent thickness T1, is preferably in the range of 0.5 to 3 mm, and more preferably 1 to 2 mm.

Each of the spacers 6 is placed so as to coincide its longitudinal direction (direction of arrow E-F) with the direction of winding of the sheet substrate 8 (direction of arrow A-B) as shown in FIG. 3 and FIG. 4. Namely, in the present invention, each of the corrugated spacers may have an apparent thickness in the range of from 0.5 to 3 mm, and in the step of winding, each of the spacers may be placed with its longitudinal direction coinciding with the direction of winding of the sheet substrate.

Then, an air passage from both sides in the traverse direction of the rolled substrate 9 to a central portion in the traverse direction is provided for each space between the respective layers adjacent to each other in the radial direction of the rolled substrate 9.

In this time, each of the spacers 6 is placed in such a manner that the spacer protrudes outward from the end of the rolled substrate 9 as shown in FIG. 3. In this way, the spacer 6 is engaged with the outer spacer 6 at the portion protruded from the rolled substrate 9 in winding and wound. Then, the wound rolled substrate 9 is fixed to some extent by virtue of engagement between the spacers 6, and thereby it is possible to prevent the occurrence of sliding between the respective layers adjacent to each other in the radial direction of the rolled substrate 9 by a force of winding. As a result, it becomes possible to significantly reduce the occurrence of a disadvantage that an inner periphery of the rolled substrate 9 is excessively tightly wound to produce wrinkles and the like.

Further, since the spacers 6 wound together into the rolled substrate 9 has a predetermined apparent thickness T1, the respective layers adjacent to each other in the radial direction of the rolled substrate 9 are separated by the apparent thickness T1 from each other. As a result, adhesion of the rolled substrate 9 due to winding can be prevented. After the rolled substrate 9 is thus prepared, the rolled substrate 9 is transferred to a step of heating (step S3 in FIG. 2) to be subjected to heat treatment.

The temperature of the heat treatment is preferably in the range of 200 to 350° C. The lower limit of the temperature of the heat treatment is more preferably 250° C., and furthermore preferably 280° C. On the other hand, the upper limit of the temperature of the heat treatment is more preferably 340° C., and furthermore preferably 330° C. Further, the time of the heat treatment is preferably in the range of 10 minutes to 15 hours. The lower limit of the time of the heat treatment is more preferably 20 minutes, and furthermore preferably 40 minutes. On the other hand, the upper limit of the time of the heat treatment is more preferably 12 hours, and furthermore preferably 10 hours. In the heat treatment, the ambience of the heat treatment may be replaced with an inert gas such as nitrogen, argon or neon or may be vacuumized from the viewpoint of preventing the degradation of a metal foil 2 due to oxidation.

In this time, since the heat treatment of the rolled substrate 9 is performed in a rolled state, not only a wide space for the heat treatment and much heat energy are not required, but also time for heat treatment is short and work efficiency is favorable. Therefore, it becomes possible to mass-produce the liquid crystalline polyester prepreg 1.

Furthermore, in the rolled substrate 9, since an air passage from both sides in the traverse direction of the rolled substrate 9 to a central portion in the traverse direction is provided for each space between the respective layers adjacent to each other in the radial direction of the rolled substrate 9 as described above, hot air is evenly supplied from both sides in the traverse direction of the rolled substrate 9 toward a central portion in the traverse direction when heating the rolled substrate. As a result, the occurrence of irregularities in quality after the heat treatment can be prevented.

At this stage, the production of the liquid crystalline polyester prepreg 1 is completed.

### Other Embodiment of Present Invention

In Embodiment 1 described above, the resin layer 3 in which the aromatic liquid crystalline polyester 4 contains the inorganic fillers 5 has been described, but the resin layer 3 in which the aromatic liquid crystalline polyester 4 does not contain the inorganic fillers 5 may be used depending on mechanical properties required for the liquid crystalline polyester prepreg 1.

Further, in Embodiment 1 described above, in order to reduce the occurrence of a disadvantage that the inner peripheral portion of the rolled substrate 9 is excessively tightly wound to produce wrinkles or the like in the step of winding into a roll, a case where the spacer 6 is placed in such a manner that the spacer protrudes outward from the end of the rolled substrate 9 has been described. However, when such a disadvantage does not take place, or when the occurrence of such a disadvantage can be reduced by another method, the spacer 6 does not have to be placed so as to protrude from the rolled substrate 9.

Furthermore, in Embodiment 1 described above, a case where the glass cloth 2 is used as an inorganic fiber sheet has been described, but inorganic fiber sheets other than the glass cloth 2 (for example, alumina fibers, silicon-containing ceramics, asbestos, rock wool, slug wool, plaster whisker (calcium sulfate whisker) and the like) can also be used in place of the glass cloth 2.

### EXAMPLES

Hereinafter, examples of the present invention will be described.

By the method in Embodiment 1 described above, the heat-treated rolled substrate of 50 m in length was prepared, and a copper-clad laminate was prototyped by sandwiching the rolled substrate between copper foils and pressing the rolled substrate with copper foils. On the other hand, a liquid crystalline polyester prepreg heat-treated not in the form of a roll but in the form of a plate was prepared, and a copper-clad laminate was prototyped by sandwiching the liquid crystalline polyester prepreg between copper foils and pressing the liquid crystalline polyester prepreg with copper foils. With respect to these two kinds of copper-clad laminates, in two directions perpendicular to each other (a flow direction (MD) in applying on an SUS foil layer and a direction perpendicular to the flow direction (TD)), a test piece of 1 cm in width was cut off and 90° peel strength of each test piece was measured. Consequently, 90° peel strength of the test piece heat-treated in the form of a plate was 10.6 N/cm (MD) and 11.1 N/cm (TD). On the other hand, 90° peel strength was 13.6 N/cm (MD) and 12.1 N/cm (TD) for the test piece taken from an area 5 meters from the open end of the rolled substrate, 13.2 N/cm (MD) and 12.6 N/cm (TD) for the test piece taken from an area 25 meters from the open end of the rolled substrate, and 11.6 N/cm (MD) and 11.4 N/cm (TD) for the test piece taken from an area 50 meters from the open end of the rolled substrate.

These results are summarized and presented in bar chart form in FIG. 5. In this bar chart, a vertical axis represents 90° peel strength (unit: N/cm). Further, the descriptions of “5 m”, “25 m” and “50 m” in a horizontal axis refer to test pieces taken from areas 5 meters, 25 meters (central portion) and 50 meters (closed end), respectively, from the open end of the rolled substrate, and the description of “Ref” refers to the test piece heat-treated in the form of a plate.

As apparent from the bar chart, it was proved that all of test pieces taken from areas 5 meters, 25 meters and 50 meters, respectively, from the open end of the rolled substrate exhibit 90° peel strength which is equal to or larger than that of the test piece heat-treated in the form of a plate.

The present invention can be widely applied to printed wiring boards (irrespective of a multilayer type or a single layer type) which are used for various uses such as communications applications, power source applications and vehicle-mounted applications.

What is claimed is:

1. A method for producing a liquid crystalline polyester prepreg, the method comprising steps of:
impregnating an inorganic fiber sheet with a solution composition containing an aromatic liquid crystalline polyester and a solvent to prepare a sheet substrate;
winding the sheet substrate into a form of roll comprising two or more layers to prepare a rolled substrate; and
heat-treating the rolled substrate;
wherein in the step of winding, corrugated spacers placed on both sides in the traverse direction of the sheet substrate are wound together with the sheet substrate.

2. The method for producing a liquid crystalline polyester prepreg according to claim 1, wherein the rolled substrate has an outer diameter in the range of from 30 to 500 mm.

3. The method for producing a liquid crystalline polyester prepreg according to claim 1, wherein each of the corrugated spacers has an apparent thickness in the range of from 0.5 to 3 mm, and wherein in the step of winding, each of the spacers is placed with its longitudinal direction coinciding with the direction of winding of the sheet substrate.

4. The method for producing a liquid crystalline polyester prepreg according to claim 1, wherein in the step of heat-treating, the rolled substrate is heat-treated at a temperature of from 200 to 350° C.

5. The method for producing a liquid crystalline polyester prepreg according to claim 1, wherein the inorganic fiber sheet is a glass cloth.

6. The method for producing a liquid crystalline polyester prepreg according to claim 1, wherein the aromatic liquid crystalline polyester has solubility in a solvent.

7. The method for producing a liquid crystalline polyester prepreg according to claim 1, wherein the aromatic liquid crystalline polyester is a liquid crystalline polyester having structural units represented by the following formulas (1), (2) and (3):
—O—Ar¹—O— (1)
-X—Ar²—Y- (2) and
—CO—Ar³—O— (3)
wherein Ar¹ represents at least one selected from the group consisting of 1,4-phenylene, 2,6-naphthylene and 4,4′-biphenylene, Ar² represents at least one selected from the group consisting of 1,4-phenylene, 1,3-phenylene and 4,4′-biphenylene, X and Y independently represent O or NH, and Ar³ represents at least one selected from the group consisting of 1,4-phenylene, 1,3-phenylene, 2,6-naphthylene and a divalent group represented by the following formula (4):
—Ar⁴—Z—Ar⁵— (4)
wherein Ar⁴ and Ar⁵ independently represent at least one selected from the group consisting of 1,4-phenylene, 2,6-naphthylene and 4,4′-biphenylene, and Z represents O, SO₂ or CO, and wherein an amount of a structural unit represented by the formula (1) is 30 to 80% by mol, an amount of a structural unit represented by the formula (2) is 35 to 10% by mol, and an amount of a structural unit represented by the formula (3) is 35 to 10% by mol with respect to the total amounts of all structural units.

8. A liquid crystalline polyester prepreg produced by the method for producing a liquid crystalline polyester prepreg according to claim 1.
